(19) United States
(12) Patent Application Publication
(10) Pub. No.: US 2012/0241251 A1
(43) Pub. Date: Sep. 27, 2012

(54) Apparatus for Working on a Roof and Method of Use Thereof

(76) Inventor: Michael Painter, Rome, GA (US)

(21) Appl. No.: 13/052,410

(22) Filed: Mar. 21, 2011

(51) Int. Cl. E04G 3/26; B23P 11/00

(52) U.S. Cl. 182/45; 29/428

(57) ABSTRACT

An apparatus for providing a stable platform for people working on inclined surfaces such as the roofs of buildings, the apparatus has a retainer to secure the apparatus to the roof, a strap attached to the retainer, a frame attached to the strap, and a support block attached to the frame, the support block being designed to allow a user to work on inclined surfaces, particularly in a seated fashion. The strap is typically attached to the frame via a cam buckle, thus allowing the user to change the position of the apparatus.

### CROSS-REFERENCE TO RELATED APPLICATIONS

### None

### FEDERALLY SPONSORED RESEARCH OR DEVELOPMENT

### None

### PARTIES TO A JOINT RESEARCH AGREEMENT

### None

### REFERENCE TO A SEQUENCE LISTING

### None

### BACKGROUND OF THE INVENTION

1. Technical Field of the Invention

The present invention relates generally to apparatus for providing a stable support platform on inclined surfaces, and more specifically to a support apparatus that can be utilized by people constructing or working on an inclined roof of a building.

2. Description of Related Art

Working on inclined surfaces, such as the roof of a house, has always presented difficulties in the construction industry. Safety concerns have frequently impeded the ability to work effectively and efficiently on the roof of a house. Unfortunately, such concerns have not yet been adequately addressed to provide for improved efficiency and safety.

To address this issue, previously it was proposed to utilize a complicated contraption that included multiple ropes to secure the contraption to a roof, multiple boards on which the worker could stand, and up to six wheels to facilitate moving on the roof. However, such devices proved unwieldy to use.

Another proposed solution was to place two ladders on opposite sides of a roof, secure a device to each ladder, and then place a board between the two devices. Although this was easier to manage than previous solutions, significant time was still expended in placing ladders on opposite sides of a building, and securing those ladders to the roof.

Another solution proposed was to nail two supports into a roof, each support being located on opposite sides of the roof, and, subsequently, placing a board between the two supports. Although this solution demanded less time to implement, in addition to the previous problem of having to safely get to either side of the roof to place the supports, after the supports were removed, the roof was left with holes where the supports were nailed to it.

Therefore, it is readily apparent that there is a need for an apparatus that is easy to manage, easy to use, and provides a stable platform for people that work on inclined surfaces such as the roof of a building.

### BRIEF SUMMARY OF THE INVENTION

Briefly described, in a preferred embodiment, the present invention overcomes the above-mentioned disadvantages and meets the recognized need for such a device by providing a stable platform apparatus for people working on inclined surfaces such as the roofs of buildings. The apparatus has a retainer to secure the apparatus to the roof, a strap attached to the retainer, a frame attached to the strap, and a support block attached to the frame, the support block being designed to allow a user to work on inclined surfaces, particularly in a seated fashion. The strap is typically attached to the frame via a cam buckle, thus allowing the user to change the position of the apparatus.

According to its major aspects and broadly stated, the present invention in its preferred form is a securing apparatus comprising a base member and a removable platform. The removable platform has a flat portion and a reinforcement. The flat portion comprises chamfered edges adapted to receive a worker's legs when the worker is seated upon the flat portion. The base member comprises a support frame, a retainer, a cam buckle and a strap. The strap is secured to the cam buckle, and the cam buckle can be manipulated to adjust the length of strap. The retainer may be a hook that has an attachment base, a first retainer member, a curved retainer member and a hooked retainer member. The hooked retainer member is adapted to be secured to a fixed portion of a roof. The fixed portion of the roof could be ridge poles or a piece of roof sheeting. The attachment base is adapted to secure the retainer to a loop in the strap.

The flat portion and the reinforcement are secured to each other. The reinforcement also comprises a relieved area, and the support frame comprises a lip. The relieved area is adapted to receive the lip. The platform is secured to the support frame via a removable fastener. The flat portion comprises an opening, and the opening and the relieved area are disposed near each other when the flat portion and the reinforcement are secured together. The support frame comprises an upturned segment, a base extension, and a terminus, and the upturned segment is located on the opposite side of the support frame from the cam buckle, and the upturned segment is further located between the base extension and the terminus, and the upturned segment is angularly disposed from the base extension.

To use one embodiment of the invention, a user would obtain the support apparatus and secure the removable portion to the base member. The base member also comprises a retainer. The support apparatus is secured via its retainer to a roof. The attachment base is adapted to secure the retainer to the strap when the strap forms a loop around the attachment base. The strap is secured to the retainer and to the cam buckle, and the cam buckle is manipulated to adjust the length of the strap.

The securing apparatus includes a base member and a removable platform. The base member has a support frame, and the support frame comprises a lip. The removable platform comprises a flat portion and a reinforcement, and the reinforcement comprises a relieved area that is capable of receiving the lip, the lip cooperatively engages the relieved area to secure the removable platform to the base member. The base member also comprises a retainer and a strap, the retainer being adapted to engage something in a fixed portion of a roof, with the strap being secured to the support frame. The removable platform is attached to the base member by a removable fastener.

More specifically, the present invention is a support apparatus comprising a base member and a removable platform. The base member comprises a retainer, a strap, a cam buckle, and a support frame. The removable platform comprises a reinforcement and a flat portion.

The retainer comprises a attachment base, a set of first retainer members, a set of curved retainer members, and a set of hooked retainer members. The strap comprises a loop, a first section, and a second section. The first section comprises a first end, and the second section comprises a second end.

The support frame comprises a first vertical post, a second vertical post, a lip, a horizontal post, a diagonal post, a first segment, a second segment, a middle segment, and an upturned segment. The first vertical post comprises a bolt hole base, and the first segment comprises a base extension and a terminus. The second vertical post comprises a top sector and a bottom sector, and the first vertical post comprises a first vertical post top and a first vertical post bottom. The horizontal post comprises a horizontal post rear and a horizontal post front.

The removable platform comprises a reinforcement and a flat portion. The reinforcement comprises a rear portion, a top portion, a right portion, a left portion, a bottom portion, a front portion, a first boundary, a second boundary, a relieved area, and a bolt hole rear. The relieved area comprises a first interior side portion, a second interior side portion, an interior bottom portion, and an interior back portion.

The flat portion comprises a front side, a back side, a right side, a left side, a right chamfer, a left chamfer, a top side, a bottom side, a bolt hole front, and an opening. The opening comprises a top edge, a right edge, a left edge, a bottom edge.

The loop is at the second end of the strap. The attachment base of the retainer is adapted to receive the loop by passing the loop around the attachment base, thereby securing the retainer to the strap. The set of first retainer members are angularly disposed on opposite sides of the attachment base, wherein the set of first retainer members are angled towards each other. The set of curved retainer members are disposed between the set of hooked retainer members and the set of first retainer members. The set of hooked retainer members and the set of curved retainer members are disposed to facilitate securing the retainer, and by extension, the support apparatus, to roof sheeting or a ridgepole. It will be recognized by those skilled in the art that the set of first retainer members could comprise could comprise one or more first retainer members. It will further be recognized by those skilled in the art that the set of curved retainer members could comprise could comprise one or more curved retainer members. It will be recognized by those skilled in the art that the set of hooked retainer members could comprise could comprise one or more hooked retainer members.

The second section is disposed between the loop and the first section. The first section of the strap is secured to the cam buckle. It will be recognized that the strap may be secured to the support frame by any securing mechanism. The cam buckle is secured to the second segment of the support frame. The middle segment of the support frame is disposed between the second segment of the support frame and the first segment of the support frame.

The bottom of the first vertical post and the bottom of the second vertical post are secured to the first segment of the support frame, the second vertical post being attached to the first segment between the terminus and the first vertical post. The diagonal post is secured to the top of the second vertical post and the diagonal post is also secured to the first vertical post near the top of the first vertical post. The horizontal post rear portion of the horizontal post is secured to the first vertical post top of the first vertical post. The lip is secured to the horizontal post front portion of the horizontal post. The bolt hole base is located between the first segment and where the diagonal post is secured to the first vertical post.

The base extension is located between the terminus and where the second vertical post is secured to the first segment. The upturned segment is angularly disposed from the base extension and may be utilized to hang objects from the support apparatus.

The top portion of the reinforcement is disposed on the opposite side of the reinforcement from the bottom portion. The left portion is disposed on the opposite side of the reinforcement from the right portion, and the front portion is placed in contact with the flat portion. The rear portion is disposed opposite the reinforcement from the front portion. The bolt hole rear is disposed in the rear portion.

The first boundary of the reinforcement is disposed between the top portion and the front portion, and the first boundary is further disposed between the relieved area and the left portion. The second boundary of the reinforcement is disposed between the top portion and the front portion, and the second boundary is further disposed between the relieved area and the right portion.

The relieved area is located between the first boundary and the second boundary, and the relieved area impinges upon both the top portion and the front portion. The first interior side portion is disposed in the relieved area towards the right portion. The second interior side portion is disposed in the relieved area towards the left portion. The interior bottom portion is disposed in the relieved area towards the bottom portion. The interior back portion is disposed in the relieved area towards the rear portion.

The back side of the flat portion is fixedly secured to, and disposed in contact with, the reinforcement. The front side is disposed opposite the flat portion from the back side. The top side is on the opposite side of the flat portion from the bottom side. The left chamfer is diagonally disposed between the left side and the top side and the right chamfer is diagonally disposed between the right side and the top side. The opening is disposed between the bolt hole front and the top side. The top edge is disposed between the opening and the top side. The right edge is disposed between the opening and the right side. The left edge is disposed between the opening and the left side. The bottom edge is disposed between the opening and the bottom side.

The right portion of the reinforcement is disposed generally coplanar to the right side of the flat portion, and the left portion of the reinforcement is disposed generally coplanar to the left side of the flat portion.

In a preferred embodiment, the reinforcement is secured to the flat portion with nails. It will be recognized by those skilled in the art that the reinforcement may be secured to the flat portion by any known means or mechanism.

The bottom portion of the reinforcement and the bottom side of the flat portion are disposed on the first segment. The reinforcement and the flat portion are prevented from axially rotating around the bolt by the first segment and/or the horizontal post. Further, the rear portion of the reinforcement is located near the first vertical post. The worker places the removable platform on the support frame by rotating the removable platform and moving the removable platform above the support frame until the lip is located in the opening of the flat portion. The worker then rotates the removable platform until the lip is located near the opening and the relieved area, engaging the relieved area.

In use, the worker secures the retainer to the roof sheeting or any secure location. The worker can also manipulate the cam buckle to adjust the length of strap between the support frame and the retainer.

The removable platform is selectively secured to the support frame by a bolt, the bolt head being located at or near the bolt hole front, and the bolt foot being located at or near the bolt hole base, and the nut being attached to the bolt foot.

The retainer may comprise metal or any similar structural material that is sufficiently rigid to support the forces exerted when the support apparatus is in use. Similarly, the strap may comprise a cloth, fabric or polymeric material that has a high tensile strength and is sufficiently flexible and resistant to the forces that are exerted upon the strap when the support apparatus is in use. The cam buckle comprises, for exemplary purposes only, a metal or similar structural material that is sufficiently rigid to support the forces exerted when the support apparatus is in use, thereby retaining the strap in a selected position. The support frame comprises, for example, a metal or hard plastic that is sufficiently rigid to support the forces exerted when the support apparatus is in use. The reinforcement and the flat portion comprise, for exemplary purposes only, a wood, metal, or plastic that is sufficiently rigid to support the forces exerted when the support apparatus is in use. It will be recognized by those skilled in the art that the retainer, the strap, the cam buckle, the support frame, the reinforcement, and the flat portion may comprise any similar or analogous material that does not compromise the functionality of the support apparatus.

In use, the support apparatus is secured to roof sheeting of a roof, the retainer being secured to the roof sheeting or a ridgepole.

In use, the worker positions herself on the flat portion up roof from the flat portion, the worker's legs being positioned over the right chamfer and the left chamfer when seated. The worker may also utilize the support apparatus by kneeling up roof from the flat portion on the roof with the worker's knees being disposed in contact with or near the flat portion. Further, the worker may also utilize the support apparatus by standing up roof from the flat portion on the roof with the worker's feet being disposed in contact with or near the flat portion. The worker can increase or decrease the length of the strap between the retainer and the support frame by adjusting the strap at or near the first end of the strap.

Accordingly, a feature and advantage of the present invention is its ability to be relatively easy to secure the apparatus to a roof.

Another feature and advantage of the present invention is its ability to provide a stable support mechanism for a person working on a roof.

Still another feature and advantage of the present invention is its ability to be moved on the roof with minimal effort by the user.

Yet another feature and advantage of the present invention is its ability to be moved on the roof without compromising the safety of the user.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of an apparatus according to a preferred embodiment, shown in use helping to support a worker;

FIG. 2 is a perspective view of a base member of the apparatus according to the preferred embodiment of FIG. 1;

FIG. 3A is a perspective view of a bottom side of a support block component of the apparatus according to the preferred embodiment of FIG. 2;

FIG. 3B is a perspective view of the top side of the support block component of FIG. 3A; and

FIG. 4 is a bottom perspective view of the apparatus according to the preferred embodiment of FIG. 2, showing the support block component secured to the base member.

### DETAILED DESCRIPTION OF THE PREFERRED AND SELECTED ALTERNATE EMBODIMENTS OF THE INVENTION

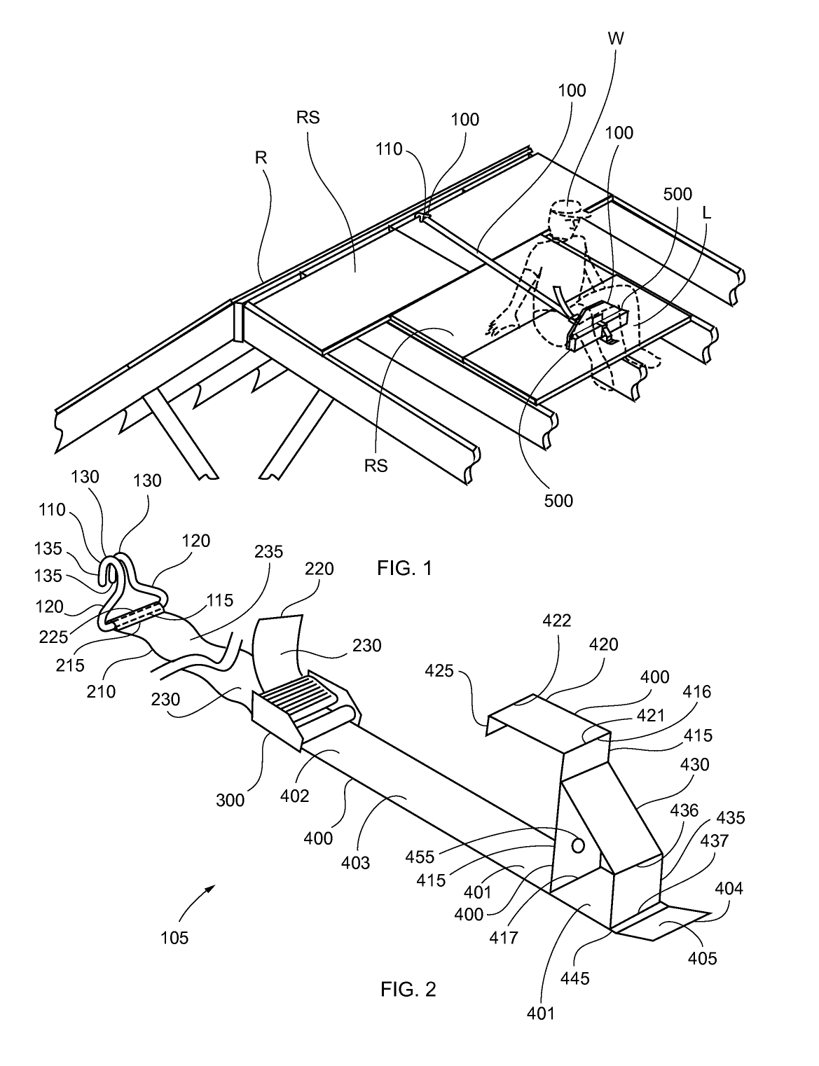

In describing the preferred and selected alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, illustrated therein is a preferred embodiment of support apparatus 100, wherein support apparatus 100 preferably comprises base member 105 and removable platform 500. Base member 105 preferably comprises retainer 110, strap 210, cam buckle 300, and support frame 400 (best shown in FIG. 2). Removable platform 500 preferably comprises reinforcement 515 and flat portion 600.

Retainer 110 preferably comprises attachment base 115, first retainer members 120, curved retainer members 130, and hooked retainer members 135. Strap 210 preferably comprises loop 215, first section 230, and second section 235, wherein first section 230 preferably comprises first end 220, and wherein second section 235 preferably comprises second end 225.

Support frame 400 preferably comprises first vertical post 415, second vertical post 435, lip 425, horizontal post 420, diagonal post 430, first segment 401, second segment 402, middle segment 403, and upturned segment 405. First vertical post 415 preferably comprises bolt hole base 455, and first segment 401 preferably comprises base extension 445 and terminus 404. Second vertical post 435 preferably comprises top sector 436 and bottom sector 437, and first vertical post 415 preferably comprises first vertical post top 416 and first vertical post bottom 417. Horizontal post 420 preferably comprises horizontal post rear 421 and horizontal post front 422.

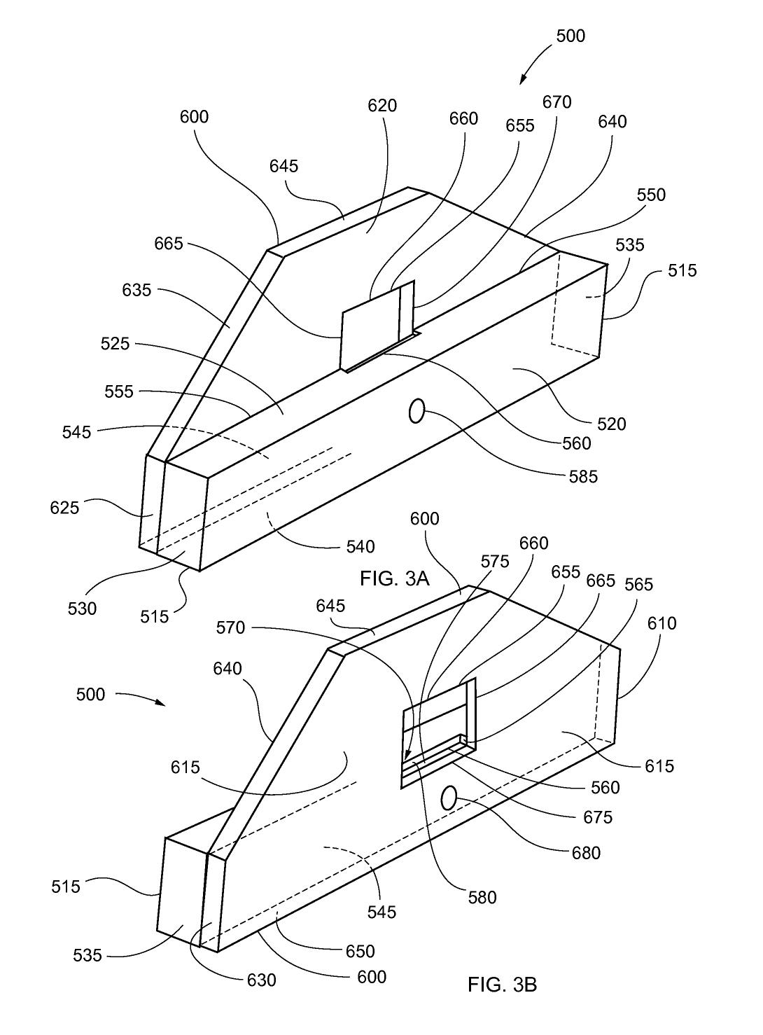

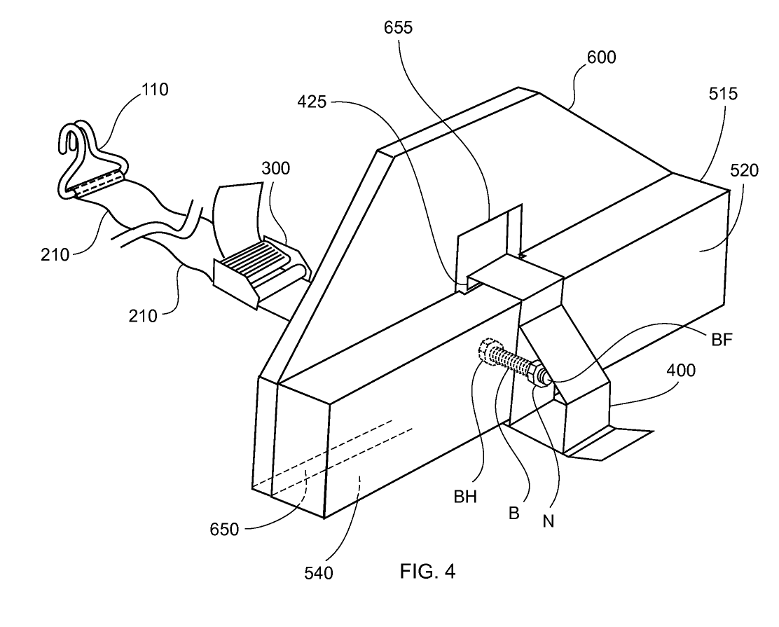

Removable platform 500 (best shown in FIGS. 3A and 3B) preferably comprises reinforcement 515 and flat portion 600. Reinforcement 515 preferably comprises rear portion 520, top portion 525, right portion 530, left portion 535, bottom portion 540, front portion 545, first boundary 550, second boundary 555, relieved area 560, and bolt hole rear 585, wherein relieved area 560 preferably comprises first interior side portion 565, second interior side portion 570, interior bottom portion 575, and interior back portion 580.

Flat portion 600 preferably comprises front side 615, back side 620, right side 625, left side 630, right chamfer 635, left chamfer 640, top side 645, bottom side 650, bolt hole front 680, and opening 655, wherein opening 655 preferably comprises top edge 660, right edge 665, left edge 670, bottom edge 675.

Loop 215 is disposed at second end 225. Attachment base 115 of retainer 110 is preferably adapted to receive loop 215, wherein loop 215 passes around attachment base 115 thereby securing retainer 110 to strap 210. First retainer members 120 are preferably angularly disposed on opposite sides of attachment base 115, wherein first retainer members 120 are preferably angled towards each other (best shown in FIG. 2). Curved retainer members 130 are disposed between hooked retainer members 135 and first retainer members 120. Hooked retainer members 135 and curved retainer members 130 are disposed to facilitate securing retainer 110, and by extension, support apparatus 100, to roof sheeting RS. It will be recognized by those skilled in the art that securing retainer 110 could alternatively be secured over ridgepole R.

Second section 235 is disposed between loop 215 and first section 230. First section 230 of strap 210 is secured to cam buckle 300. It will be recognized by those skilled in the art that strap 210 may be secured to support frame 400 by any securing mechanism. Cam buckle 300 is secured to second segment 402 of support frame 400. Middle segment 403 of support frame 400 is disposed between second segment 402 of support frame 400 and first segment 401 of support frame 400.

First vertical post 415 and second vertical post 435 are secured to first segment 401 of support frame 400, wherein second vertical post 435 is secured to first segment 401 between terminus 404 and first vertical post 415 (best shown in FIG. 2), and wherein first vertical post bottom 417 of first vertical post 415 is secured to first segment 401 (best shown in FIG. 2), and wherein bottom sector 437 of second vertical post 435 is secured to first segment 401. Diagonal post 430 is secured to top sector 436 of second vertical post 435 and diagonal post 430 is further secured to first vertical post 415 proximate or below first vertical post top 416. Horizontal post rear 421 of horizontal post 420 is secured to first vertical post top 416 of first vertical post 415. Lip 425 is secured to horizontal post front 422 of horizontal post 420. Bolt hole base 455 is disposed between first segment 401 and where diagonal post 430 is secured to first vertical post 415 (best shown in FIG. 2).

Base extension 445 is disposed between terminus 404 and where second vertical post 435 is secured to first segment 401 (best shown in FIG. 2). Upturned segment 405 is angularly disposed from base extension 445 (best shown in FIG. 2).

Turning now more particularly to FIG. 3A, top portion 525 and bottom portion 540 are disposed opposite each other. Left portion 535 and right portion 530 are disposed opposite each other, and front portion 545 is disposed in contact with flat portion 600 (best shown in FIG. 4). Rear portion 520 and front portion 545 are disposed opposite each other. Bolt hole rear 585 is disposed in rear portion 520.

First boundary 550 of reinforcement 515 is disposed between top portion 525 and front portion 545 (best shown in FIG. 3A), and first boundary 550 is further disposed between relieved area 560 and left portion 535 (best shown in FIG. 3A). Second boundary 555 of reinforcement 515 is disposed between top portion 525 and front portion 545 (best shown in FIG. 3A), and second boundary 555 is further disposed between relieved area 560 and right portion 530 (best shown in FIG. 3A).

Relieved area 560 is disposed between first boundary 550 and second boundary 555 (best shown in FIG. 3A). Relieved area 560 impinges upon both top portion 525 and front portion 545. First interior side portion 565 is disposed in relieved area 560 towards right portion 530 (best shown in FIG. 3B). Second interior side portion 570 is disposed in relieved area 560 towards left portion 535, wherein second interior side portion 570 is disposed opposite relieved area 560 from first interior side portion 565. Interior bottom portion 575 is disposed in relieved area 560 towards bottom portion 540 (best shown in FIG. 3B). Interior back portion 580 is disposed in relieved area 560 towards rear portion 520 (best shown in FIG. 3B).

Back side 620 of flat portion 600 is fixedly secured to, and disposed in contact with, reinforcement 515 (best shown in FIG. 3A). Front side 615 and back side 620 are each other (best shown in FIG. 3B). Top side 645 and bottom side 650 are disposed opposite each other. Left chamfer 640 is diagonally disposed between left side 630 and top side 645 (best shown in FIG. 3B). Right chamfer 635 is diagonally disposed between right side 625 and top side 645 (best shown in FIG. 3A). Opening 655 is disposed between bolt hole front 680 and top side 645 (best shown in FIG. 3B). Top edge 660 is disposed between opening 655 and top side 645 (best shown in FIG. 3B). Right edge 665 is disposed between opening 655 and right side 625 (best shown in FIG. 3B). Left edge 670 is disposed between opening 655 and left side 630 (best shown in FIG. 3B). Bottom edge 675 is disposed between opening 655 and bottom side 650 (best shown in FIG. 3B).

Right portion 530 is disposed generally coplanar to right side 625 (best shown in FIG. 3A), and left portion 535 is disposed generally coplanar to left side 630 (best shown in FIG. 3B).

Now referring to FIG. 4, in use, reinforcement 515 and flat portion 600 are disposed on first segment 401 (best shown in FIG. 4), wherein reinforcement 515 and flat portion 600 are prevented from axially rotating around bolt B by first segment 401 or horizontal post 420, and wherein bottom portion 540 of reinforcement 515 is disposed on first segment 401, and wherein bottom side 650 of flat portion 600 is disposed on first segment 401 (best shown in FIG. 4). Further, rear portion 520 of reinforcement 515 is disposed proximate to first vertical post 415 (best shown in FIG. 4). Worker W preferably places removable platform 500 on support frame 400 by axially rotating removable platform 500 (not shown), moving removable platform 500 above support frame 400 wherein lip 425 is located in opening 655 of flat portion 600, and again axially rotating removable platform 500 wherein lip 425 is located proximate to opening 655 and relieved area 560 (best shown in FIG. 4).

Worker W secures retainer 110 to roof sheeting RS. It will be recognized by those skilled in the art that retainer 110 may be secured to any structure or element of a structure. In use, worker W manipulates cam buckle 300 to adjust the length of strap 210.

In a preferred embodiment, reinforcement 515 is secured to flat portion 600 with nails. It will be recognized by those skilled in the art that reinforcement 515 may be secured to flat portion 600 by any known means or mechanism.

Removable platform 500 is preferably selectively secured to support frame 400 by bolt B, wherein bolt head BH of bolt B is disposed at or near bolt hole front 680, and wherein bolt foot BF of bolt B is disposed at or near bolt hole base 455, and wherein nut N is selectively secured to bolt foot BF of bolt B (best shown in FIG. 4).

Retainer 110 preferably comprises, for exemplary purposes only, metal or similar structural material that is sufficiently rigid to support the forces exerted when support apparatus 100 is in use. Strap 210 preferably comprises, for exemplary purposes only, cloth, fabric or polymeric material that is sufficiently flexible, with high tensile strength, and sufficiently resistant to the forces that are exerted upon strap 210 when support apparatus 100 is in use. Cam buckle 300 preferably comprises, for exemplary purposes only, metal or similar structural material that is sufficiently rigid to support the forces exerted when support apparatus 100 is in use. Support frame 400 preferably comprises, for exemplary purposes only, metal or hard plastic that is sufficiently rigid to support the forces exerted when support apparatus 100 is in use. Reinforcement 515 preferably comprises, for exemplary purposes only, wood, metal, or plastic that is sufficiently rigid to support the forces exerted when support apparatus 100 is in use. Flat portion 600 preferably comprises, for exemplary purposes only, wood, metal, or plastic that is sufficiently rigid to support the forces exerted when support apparatus 100 is in use. It will be recognized by those skilled in the art that retainer 110, strap 210, cam buckle 300, support frame 400, reinforcement 515, and flat portion 600 may comprise any similar or analogous material that does not compromise the functionality of support apparatus 100.

Returning now more particularly to FIG. 1, support apparatus 100 is preferably secured to roof sheeting RS of roof R, wherein retainer 110 of support apparatus 100 is selectively secured to roof sheeting RS, and wherein at least one of curved retainer components 130 of retainer 110 is selectively secured to roof sheeting RS or at least one of hooked retainer components 135 of retainer 110 is selectively secured to roof sheeting RS.

In use, worker W positions herself at first segment 401, second segment 402, or middle segment 403, wherein legs L of worker W are positioned over right chamfer 635 and left chamfer 640. Worker W can selectively increase or decrease the length of strap 210 between retainer 110 and support frame 400 by adjusting strap 210 at or near first end 220, wherein adjusting strap 210 either increases or decreases the length of strap 210 between retainer 110 and support frame 400.

In an alternate embodiment (not shown), retainer 110 comprises one first retainer member 120, one curved retainer member 130, and one hooked retainer member 135.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A securing apparatus comprising:
a base member; and
a removable platform, wherein said removable platform comprises a flat portion and a reinforcement, and wherein said flat portion comprises chamfered edges adapted to receive a worker's legs when the worker is seated upon said flat portion.

2. The securing apparatus of claim 1, wherein said base member comprises a support frame, a retainer, a cam buckle and a strap.

3. The securing apparatus of claim 2, wherein said cam buckle cooperatively engages with said strap, said support frame and said retainer to adjust the length of said base member.

4. The securing apparatus of claim 3, wherein said retainer comprises a hook.

5. The securing apparatus of claim 4, wherein said hook comprises an attachment base, at least one first retainer member, at least one curved retainer member and at least one hooked retainer member.

6. The securing apparatus of claim 5, wherein said at least one hooked retainer member is adapted to cooperatively engage a fixed portion of a roof.

7. The securing apparatus of claim 6, wherein the fixed portion of the roof is selected from the group consisting of roof sheeting and roof ridge poles.

8. The securing apparatus of claim 7, wherein said attachment base is adapted to secure said retainer to said strap when said strap forms a loop around said attachment base.

9. The securing apparatus of claim 1, wherein said flat portion and said reinforcement are fixedly-secured together.

10. The securing apparatus of claim 2, wherein said reinforcement further comprises a relieved area, and wherein said support frame comprises a lip, and wherein said relieved area is adapted to receive said lip.

11. The securing apparatus of claim 10, wherein said platform is secured to said support frame via a removable fastener.

12. The securing apparatus of claim 11, wherein said flat portion comprises an opening, and wherein said opening and said relieved area are disposed proximate to each other when said flat portion and said reinforcement are secured to each other.

13. The securing apparatus of claim 8, wherein said support frame comprises an upturned segment, a base extension, and a terminus, and wherein said upturned segment is located between said base extension and said terminus, and wherein said upturned segment is disposed opposite said support frame from said cam buckle, and wherein said upturned segment is angularly disposed from said base extension.

14. A method of providing a stable platform for a worker on a roof, said method comprising the steps of:
obtaining a support apparatus comprising a base member and a removable platform, wherein said removable platform comprises a flat portion and a reinforcement, and wherein said flat portion comprises chamfered edges adapted to receive a worker's legs when the worker is seated upon said flat portion;
securing said removable platform to said base member.

15. The method of claim 14, wherein said base member comprises a retainer, said method further comprising the step of:
securing said retainer to a roof.

16. The method of claim 15, wherein said base member further comprises a support frame, a cam buckle and a strap, and wherein said retainer comprises an attachment base, and wherein said attachment base is adapted to secure said retainer to said strap when said strap forms a loop around said attachment base, said method further comprising the steps of:
securing said strap to said retainer; and
securing said strap to said cam buckle.

17. The method of claim 16, said method further comprising the steps of:
manipulating said cam buckle; and
adjusting the length of said strap.

18. A securing apparatus comprising:
a base member, wherein said base member comprises a support frame, and wherein said support frame comprises a lip; and
a removable platform, wherein said removable platform comprises a flat portion and a reinforcement, and wherein said reinforcement comprises a relieved area, and wherein said relieved area is adapted to receive said lip, and wherein said lip cooperatively engages said relieved area to secure said removable platform to said base member.

19. The securing apparatus of claim 18, wherein said base member further comprises a retainer and a strap, and wherein said retainer is adapted to cooperatively engage a fixed portion of a roof, and wherein said strap is secured to said support frame.

20. The securing apparatus of claim 19, wherein said removable platform is selectively secured to said base member via a removable fastener.
